(19) United States
(12) Patent Application Publication
(10) Pub. No.: US 2006/0257717 A1
(43) Pub. Date: Nov. 16, 2006

(54) Gas diffusion electrode and method for making same

(75) Inventor: Chuan-De Huang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/287,127

(22) Filed: Nov. 23, 2005

(30) Foreign Application Priority Data
May 14, 2005 (CN) 200510034682.9

(51) Int. Cl. H01M 4/94; H01M 4/88; C25D 5/18

(52) U.S. Cl. 429/44; 502/101; 205/104

(57) ABSTRACT

The gas diffusion electrode includes a gas diffusion layer, an intermediate layer formed on the gas diffusion layer, and a catalyst layer formed on the intermediate layer. The intermediate layer has a crystal structure configured to serve as a crystal seed for the formation of the catalyst layer thereon. The method includes the steps of providing a gas diffusion layer; forming a intermediate layer on the gas diffusion layer, the intermediate layer having a crystal structure; and growing a catalyst layer on the intermediate layer by employing the intermediate layer as a crystal seed.

### BACKGROUND OF THE INVENTION

1. Field of the Invention

The present invention relates to fuel cells and, more particularly, to a gas diffusion electrode for use in a fuel cell and a method for manufacturing the same.

2. Discussion of the Related Art

A fuel cell is a device for generating electricity. The fuel cell operates based on electrochemical reactions. Significant attention has been focused in the past few years on the development of fuel cell technology. At the present time, governments of the United States, Japan, Canada and other developed countries have constituted correlative policies to develop fuel cells.

When a fuel cell works, fuel gases (such as hydrogen) and combustion-supporting agents (such as oxygen) are supplied separately to an anode and a cathode, so as to effect redox (i.e., oxidation-reduction) reactions. Such redox reactions can be used to convert chemical energy into electrical energy. Used to facilitate the electrochemical reaction is a membrane electrode assembly (MEA). The MEA is a hard core of the fuel cell system. The structure of the MEA resembles a sandwich, which is formed with a proton exchange membrane sandwiched between the anode and the cathode.

The anode and the cathode both can be catalyst electrodes, and preferably the two catalyst electrodes are gas diffusion electrodes. Generally, a given gas diffusion electrode includes a gas diffusion layer and a catalyst layer. The gas diffusion layer is provided for allowing the reaction gases to pass therethrough and reach the catalyst layer, while preventing the electrolyte or water from reverse osmosis. The gas diffusion layer also functions as a current collector. In addition, the gas diffusion layer is beneficial to enhance the mechanical strength of the electrode and protects that electrode from damage during the process of manufacturing.

Performances of the catalyst layers and materials of the respective electrodes can directly affect the work efficiency of the fuel cells. Conventional methods for making the catalyst layers include a deposition method and a dipping method. A typical deposition method for making a Pt/C catalyst layer includes the steps of employing a platinum sulfite as a raw material to react with a hydrogen peroxide to get a colloid of PtOₓ and then loading the colloid of PtOₓ on a carbon black matrix to obtain the Pt/C catalyst layer. A main step of the dipping method is to cause the platinum permeate into a carbon black carrier. The platinum within the carbon black carrier is in the form of chloroplatinate ions or platinum ammonia complex ions. A typical dipping method is disclosed in U.S. Pat. No. 3,857,737. The patent discloses a method for making a Pt/C catalyst layer, by using carbon black as a carrier and employing platinum ammonia complex ions.

However, in the above described methods, the platinum that is diffused into the carbon black carrier is in an oxidation state or an ionic state (i.e., a charged state). The platinum is then transformed into a metal state (i.e., a neutral state) by a reduction reaction or a heating process. In this process, the platinum atoms in the metal state are prone to reagglomerate with each other and thereby tend to not remain uniformly distributed in the carbon black carrier.

Accordingly, what is needed, therefore, is a gas diffusion electrode of which a catalyst layer and a gas diffusion layer are firmly attached to each other and in which the platinum atoms remain uniformly distributed.

### SUMMARY

One embodiment of a gas diffusion electrode includes a gas diffusion layer, an intermediate layer, and a catalyst layer. The intermediate layer is formed on the gas diffusion layer, and the catalyst layer is created on the intermediate layer. The intermediate layer has a crystal structure configured to serve as a crystal seed for the formation of the catalyst layer thereon.

The material of the intermediate layer is a catalytic metal.

The material of the intermediate layer is same as that of the catalyst layer.

The material of the middle layer is selected from the group consisting of Ni, Pd, Pt, Ru, Au, and alloys of such metals.

Another embodiment provides a method for manufacturing a gas diffusion electrode, the method including:

(a) providing a gas diffusion layer;

(b) forming a intermediate layer on the gas diffusion layer, the intermediate layer having a crystal structure; and

(c) growing a catalyst layer on the intermediate layer by employing the intermediate layer as a crystal seed.

Preferably, the gas diffusion layer is treated by a hydrophobic treatment process prior to forming the intermediate layer thereon.

The intermediate layer is formed on the gas diffusion layer employing a vapor deposition means.

The vapor deposition process is selected from the group consisting of a vacuum evaporation process, a sputtering process, and an ion plating process.

The catalyst layer is formed on the intermediate layer employing a liquid deposition means.

Preferably, the liquid deposition process is a pulse electrolysis process.

It is of advantage that the intermediate layer is configured to be between the gas diffusion layer and the catalyst layer. By using the intermediate layer as a seed crystal for forming the catalyst layer, the obtained intermediate layer and the catalyst layer have an excellent bonding power, thereby being firmly attached to each other. This configuration also avoids affecting the electrical conductivity of the gas diffusion electrode. In addition, the intermediate layer of the gas diffusion electrode is formed by the vapor deposition technique, and catalyst layer is formed by the liquid deposition technique. The use of this set of forming techniques can reduce cost effectively. Furthermore, by performing the pulse electrolysis process, the obtained catalyst layer has a fine crystal structure with low or no porosity and good physico-chemical performance.

### BRIEF DESCRIPTION OF THE DRAWING

Many aspects of the present gas diffusion electrode can be better understood with reference to the following drawing. The components in the drawing are not necessarily to scale, the emphasis instead being placed upon clearly illustrating the principles of the present electrode. Moreover, in the drawing, like reference numerals designate corresponding parts throughout the several views.

FIG. 1 is a schematic, cross-sectional view of a fuel cell unit, in accordance with a preferred embodiment.

### DETAILED DESCRIPTION OF THE PREFERRED EMBODIMENT

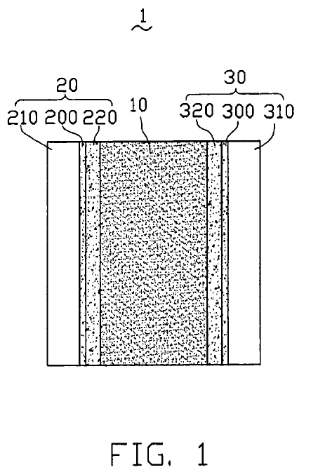

FIG. 1 shows a fuel cell unit 1, in accordance with a preferred embodiment. The fuel cell unit 1 includes an anode 20, a cathode 30, and an electrolyte membrane 10 sandwiched therebetween. The anode 20 and the cathode 30 are both gas diffusion electrodes.

The anode 20 includes a gas diffusion anode layer 210, a catalyst layer 220, and an intermediate layer 200. The intermediate layer 200 is sandwiched between the gas diffusion anode layer 210 and the catalyst layer 220.

Similarly, the cathode 30 includes a gas diffusion cathode layer 310, a catalyst layer 320, and an intermediate layer 300. The intermediate layer 300 is sandwiched between the gas diffusion cathode layer 310 and the catalyst layer 320.

The material of the gas diffusion anode layer 210 and the gas diffusion cathode layer 310 is advantageously a solid, gas-permeable, electrically-conductive, carbon-fiber composite. For example, the material used for layers 210, 310 may be a carbon-fiber fabric or a carbon-fiber paper. The material of the catalyst layer 220 of the anode 20 and the catalyst layer 320 of the cathode 30 can be selected from the group consisting of Ni, Pd, Pt, Ru, and Au, and alloys of such metals. The material of the intermediate layer 200 of the anode 20 and the intermediate layer 300 of the cathode 30 may be a catalytic metal and is advantageously same as that of the catalyst layer 220,320, such as Ni, Pd, Pt, Ru, Au, and their alloys. The methods for forming the intermediate layers 200 and 300 are different from those for forming the catalyst layers 220 and 320. Accordingly, the structures of the intermediate layers 200, 300 are typically different from those of the catalyst layers 220, 320, correspondingly.

A method for manufacturing the anode 20 in accordance with a preferred embodiment includes the steps of:

(1) providing a gas diffusion anode layer 210;

(2) forming an intermediate layer 200 on the gas diffusion anode layer 210; and

(3) forming a catalyst layer 220 on the intermediate layer 200, thereby obtaining the anode 20.

In step (1), the gas diffusion anode layer 210 is made of a gas-permeable, electrically conductive material, for example carbon-fiber fabric. A thickness of the gas diffusion anode layer 210 is configured to be about in the range from 0.3 millimeters to 0.35 millimeters. The electrically conductive material is generally subject to a graphitization treatment under high temperatures, in order to obtain a suitable electrical conductivity and improve the resistance to corrosion thereof.

The gas diffusion anode layer 210 generally needs to be subjected to a hydrophobic treatment process before the intermediate layer 200 is formed thereon. This process is configured for ensuring that the water and reaction gases can smoothly pass through the gas diffusion anode layer 210 and then reach the catalyst layer 220. Polytetrafluoroethylene (PTFE) is generally used in the hydrophobic treatment process. In the hydrophobic treatment process, the PTFE is dispersed into the gas diffusion anode layer 210. The PTFE can prevent the water molecules and the reaction gases from being agglomerated within the gas diffusion anode layer 210, thereby avoiding blockage of the gas diffusion anode layer 210. Therefore, the working efficiency of the fuel cell unit 1 is improved.

In step (2), the intermediate layer 200 is formed on the hydrophobic gas diffusion anode layer 210 by a liquid deposition process or a vapor deposition process. The liquid deposition process may be chosen, e.g., from a group including an electrolysis method, a plating method, an electroless plating method, and an electrophoresis method. A liquid deposition process has the advantages of easy operation and low cost associated therewith. The vapor deposition process can, for example, be a chemical vapor deposition method or a physical vapor deposition method. The physical vapor deposition method may entail, e.g., an evaporation plating method, a sputtering method, or an ion plating method. The intermediate layer 200 is, advantageously, formed by the sputtering method.

The material of the gas diffusion anode layer 210 usefully is carbon. If the catalyst layer 220 is directly deposited on the gas diffusion anode layer 210 by a liquid deposition process, the bonding power between the gas diffusion anode layer 210 and the catalyst layer 220 is weak, whereby the electrical conductivity of the gas diffusion anode electrode 20 overall may be decreased. In addition, it is relatively expensive to form the anode catalyst layer 220 by a vapor deposition process. In the preferred embodiment, therefore, the intermediate layer 200 is deposited on the gas diffusion anode layer 210 by a vapor deposition process. The intermediate layer 200 functions as a seed crystal for the catalyst layer 220 to be formed in a later step. By doing so, the catalyst layer 220 can be firmly formed on the gas diffusion anode layer 210. The material of the intermediate layer 200 is, advantageously, composed of a catalytic metal. Even though a more expensive vapor deposition technique may be used in forming the intermediate layer 200, this layer 200 is, usefully, not nearly as thick as the catalyst layer 220, helping to minimize the cost involved. Moreover, the intermediate layer 200, in turn, facilitates the formation of the catalyst layer 220, further justifying the cost of the intermediate layer 200.

In step (3), the catalyst layer 220 is formed on the intermediate layer 200. The intermediate layer 200 and the catalyst layer 220 are, advantageously, both made of a catalytic metal, such as Ni, Pd, Pt, Ru, Au and their alloys. Even more advantageously, the intermediate layer 200 and the catalyst layer 220 are formed of a same or essentially the same material or of different materials having a similar crystal structure to further promote the bonding compatibility thereof. The catalyst layer 220 is, beneficially, formed on the intermediate layer 200 by a liquid deposition method. Because the methods for forming the intermediate layer 200 and the catalyst layer 220 are different, the structures thereof are correspondingly different. Yet, because the materials of the two layers are similar, the two layers can be firmly adhered to each other. Thus, the gas diffusion anode layer 210 and the catalyst layer 220 are firmly attached to each other via the anode middle layer 200.

A process for forming the anode catalyst layer 220 will be described in detail as follows. The gas diffusion anode layer 210 with the anode middle layer 200 formed thereon is used as a cathode electrode. An inert electrode is used as an anode electrode. The cathode electrode and the anode electrode are immersed into an electrolyte solution. The electrolyte solution can be selected from ruthenium chloride (RuCl₃), platinum chloride (H₂PtCl₆), and so on. Once power is applied between the anode electrode and the cathode electrode, the ruthenium ions or the platinum ions, for example, are reduced into metal ruthenium or metal platinum and are deposited onto the intermediate layer 200, thereby obtaining the anode catalyst layer 220.

Preferably, a pulse power is applied between the anode electrode and the cathode electrode, for supplying a pulse electric current. By doing so, the catalyst layer 220 generally has an excellent crystal structure with low or even no porosity has a strong bonding power compatibility with the intermediate layer 200, and has a better physico-chemical performance.

The method for making the cathode 30 is similar to that for making the anode 20, except that the cathode 30 is made by using the cathode gas diffusion layer 310 as a substrate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A gas diffusion electrode comprising:
a gas diffusion layer;
an intermediate layer formed on the gas diffusion layer, the intermediate layer comprises a crystal structure configured to serve as a crystal seed;
a catalyst layer formed on the intermediate layer, the crystal structure of the intermediate layer being configured for promoting the formation of the catalyst layer thereon.

2. The gas diffusion electrode as described in claim 1, wherein the intermediate layer is comprised of a catalytic metal.

3. The gas diffusion electrode as described in claim 1, wherein a material of the intermediate layer is essentially the same as that of the catalyst layer.

4. The gas diffusion electrode as described in claim 1, wherein the catalyst layer is comprised of a material selected from the group consisting of Ni, Pd, Pt, Ru, and Au, and alloys of such metals.

5. A method for manufacturing a gas diffusion electrode, comprising the steps of:
(1) providing a gas diffusion layer;
(2) forming a intermediate layer on the gas diffusion layer, the intermediate layer having a crystal structure; and
(3) growing a catalyst layer on the intermediate layer, the crystal structure of the intermediate layer acting as a crystal seed for promoting the growth of the catalyst layer.

6. The method as described in claim 5, wherein the intermediate layer is comprised of a catalytic metal.

7. The method as described in claim 5, wherein the intermediate layer and the catalyst layer are comprised of essentially the same material.

8. The method as described in claim 5, wherein the catalyst layer is comprised of a material selected from the group consisting of Ni, Pd, Pt, Ru, and Au, and alloys of such metals.

9. The method as described in claim 5, wherein the gas diffusion layer is treated by a hydrophobic treatment process prior to forming the intermediate layer thereon.

10. The method as described in claim 5, wherein the intermediate layer is formed on the gas diffusion layer by a vapor deposition process.

11. The method as described in claim 10, wherein the vapor deposition process is selected from the group consisting of a vacuum evaporation process, a sputtering process, and an ion plating process.

12. The method as described in claim 5, wherein the catalyst layer is formed on the intermediate layer by a liquid deposition process.

13. The method as described in claim 12, wherein the liquid deposition process is a pulse electrolysis process.

14. A fuel cell comprising an anode, a cathode, and an electrolyte membrane sandwiched therebetween, the anode and the cathode each respectively comprising a gas diffusion layer, an intermediate layer formed on the gas diffusion layer, and a catalyst layer formed on the intermediate layer, the intermediate layer comprising a crystal structure configured to serve as a crystal seed for the formation of the catalyst layer thereon.
